(19) United States
(12) Patent Application Publication
(10) Pub. No.: US 2003/0202668 A1
(43) Pub. Date: Oct. 30, 2003

(54) Earphone type transmitter and receiver apparatus

(76) Inventor: Kuo-Kun Kao, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/131,398

(22) Filed: Apr. 25, 2002

(51) Int. Cl. H04R 1/10; H04M 1/00

(52) U.S. Cl. 381/74; 379/430

(57) ABSTRACT

An earphone type transmitter receiver apparatus is constructed to include a housing adapted for inserting into the user's ear, the housing having a front opening covered with a grille and an earphone cushion on the grille, a speaker mounted in an inside wall of the grille for output of sound from an external sound source; and a microphone mounted in a forwardly extended center barrel of the grille for picking up the user's sound waves from the ear of the user in which the housing is inserted.

### BACKGROUND OF THE INVENTION

1. Field of the Invention

The present invention relates to earphones and, more specifically, to an earphone type transmitter receiver apparatus for use with a mobile telephone, which eliminates the interference of surrounding noises.

2. Description of the Related Art

Various earphones with microphone have been disclosed for use with a mobile telephone, and have appeared on the market. FIG. 9 illustrates an earphone with microphone 7 according to the prior art. The earphone with microphone 7 comprises an earphone 71 and a microphone 72. The earphone 71 is adapted for inserting into the user's ear for output of sound from the mobile telephone 3. The microphone 72 is adapted to pick up the user's voice for transmitting through the mobile telephone. Because the microphone 72 picks up the user's voice from the open air, surrounding noises may interfere with the user's voice.

FIG. 10 illustrates another structure of earphone with microphone 8 according to the prior art. According to this design, the earphone with microphone 8 comprises a housing 81, a grille 82 covered on the front opening of the housing 81, a speaker 83 fixedly mounted in the inside wall of the grille 82 inside the housing 81, a back chamber 85 at the back side of the housing 81, and a microphone 84 mounted in the back chamber 85 and adapted for picking up the user's voice from the open air. Because the microphone 84 is remote from the user's mouse, it may not be able to pick up the user's voice clearly. Further, the microphone 84 cannot eliminate surrounding noises when picking up the user's voice.

FIG. 11 illustrates still another prior design of earphone with microphone 9. According to this design, the earphone with microphone 9 comprises an elongated casing 91, a speaker 93 installed in one end of the casing 91, a microphone 94 installed in the other end of the casing 91, and a hook 92 protruded from one end of the casing 91 adjacent to the speaker 93. When in use, the hook 92 is fastened to the user's ear to secure the microphone 93 closely attached to the user's ear, keeping the microphone 94 suspended near the user's mouth. This design still cannot eliminate interferences of surrounding noises.

### SUMMARY OF THE INVENTION

The present invention has been accomplished to provide an earphone type transmitter receiver apparatus, which eliminates the aforesaid drawbacks. It is one object of the present invention to provide an earphone type transmitter receiver apparatus, which eliminates the interference of surround noises. According to one aspect of the present invention, the earphone type transmitter receiver apparatus comprises a housing adapted for inserting into the user's ear, the housing having a front opening covered with a grille and an earphone cushion on the grille, a speaker mounted in an inside wall of the grille for output of voice signal from an external mobile telephone to which the earphone type transmitter receiver apparatus is connected; and a microphone mounted in a forwardly extended center barrel of the grille for picking up the user's sound waves from the ear of the user in which the housing is inserted. According to another aspect of the present invention, a wireless transmitting receiving circuit assembly is installed in the housing and electrically connected to the microphone and the speaker for communication with an external mobile telephone by radio.

### BRIEF DESCRIPTION OF THE DRAWINGS

FIG. 1 is an exploded view of an earphone type transmitter receiver apparatus according to a first embodiment of the present invention.

FIG. 2 is a sectional assembly view of the earphone type transmitter receiver apparatus according to the first embodiment of the present invention.

FIG. 3 is a schematic drawing showing the earphone type transmitter receiver apparatus inserted into the user's ear according to the present invention.

FIG. 4 illustrates the earphone type transmitter receiver apparatus connected to a mobile telephone according to the present invention.

FIG. 5 is a sectional view of the earphone type transmitter receiver apparatus showing a wireless transmitting receiving circuit assembly installed in the housing and electrically connected to the microphone and the speaker according to the present invention.

FIG. 6 is a sectional view of an earphone type transmitter receiver apparatus constructed according to a second embodiment of the present invention.

FIG. 7 is a sectional view of an earphone type transmitter receiver apparatus constructed according to a third embodiment of the present invention.

FIG. 8 is a sectional view of an earphone type transmitter receiver apparatus constructed according to a fourth embodiment of the present invention.

FIG. 9 illustrates an earphone with microphone for use with a mobile telephone according to the prior art.

FIG. 10 illustrates another structure of earphone with microphone according to the prior art.

FIG. 11 is a perspective view of still another structure of earphone with microphone according to the prior art.

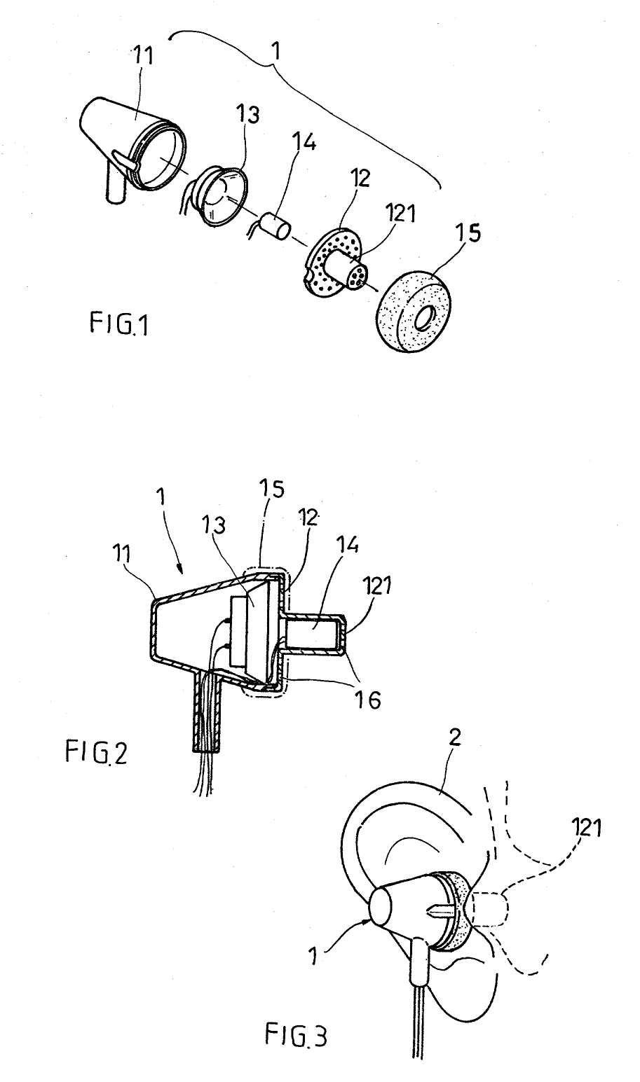

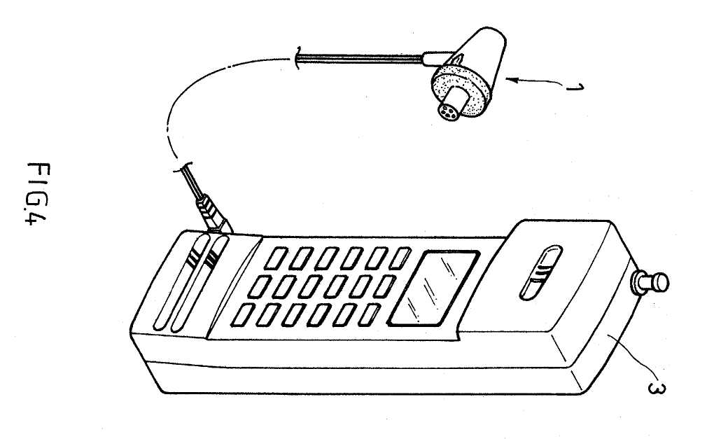

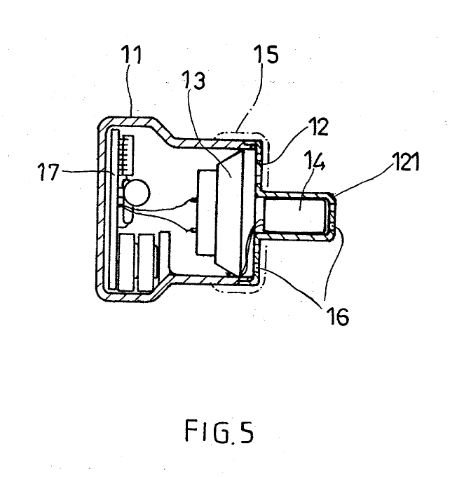

### DETAILED DESCRIPTION OF THE PREFERRED EMBODIMENT

Referring to FIGS. from 1 through 4, an earphone type transmitter receiver apparatus 1 is shown comprising a housing 11, a grille 12 covered on the front opening of the housing 11, the grille 12 having a forwardly protruded center barrel 121 and pores 16, a microphone 14 mounted in the center barrel 121, a speaker 13 mounted in the inside wall of the grille 12 inside the housing 11 for output of sound, and an earphone cushion 15 fastened to the housing 11 and covered on the grille 12 around the center barrel 121. When connected to the earphone jack of a mobile telephone 3 and inserted into the ear 2, the voice of the person at the remote side is received by the mobile telephone 3 and then outputted through the speaker 13, and the voice of the user of the mobile telephone 3 is picked up by the microphone 14, and then transmitted to the person at the remote side through the mobile telephone 3.

Referring to FIG. 5, a wireless transmitting and receiving circuit assembly 17 is installed in the housing 11 and electrically connected to the speaker 13 and the microphone 14 for communication with a mobile telephone by radio.

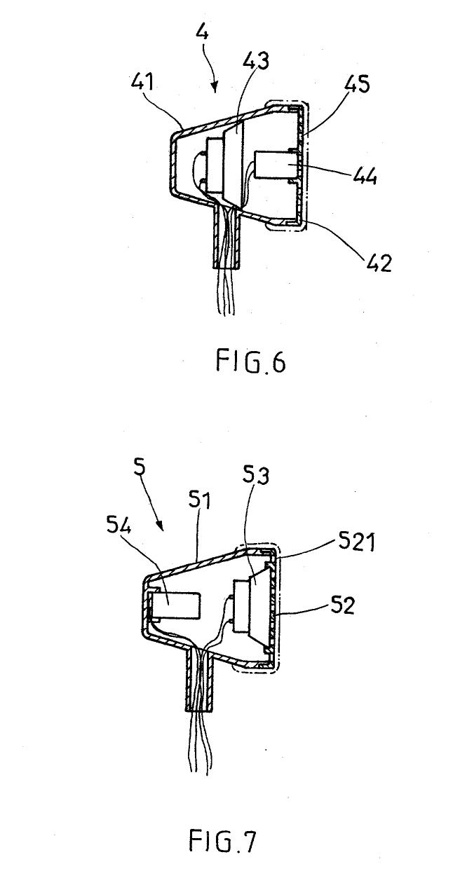

FIG. 6 shows an earphone type transmitter receiver apparatus 4 according to a second embodiment of the present invention. According to this embodiment, the earphone type transmitter receiver apparatus 4 comprises a housing 41, a speaker 43 mounted inside the housing 41 for output of sound, a grille 42 covered on the front opening of the housing 41, a microphone 44 mounted in the center of the inside wall of the grille 42 inside the housing 41, and an earphone cushion 45 covered on the grille 42.

FIG. 7 shows an earphone type transmitter receiver apparatus 5 according to a third embodiment of the present invention. According to this embodiment, the earphone type transmitter receiver apparatus 5 comprises a housing 51, a grille 52 covered on the front opening of the housing 51, the grille 52 having pores 521, a speaker 53 mounted on the inside wall of the grille 52, and an earphone 54 mounted in the inner side of the housing 51 remote from the grille 52.

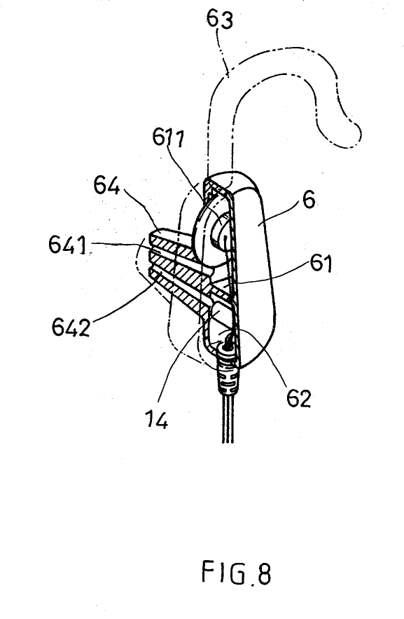

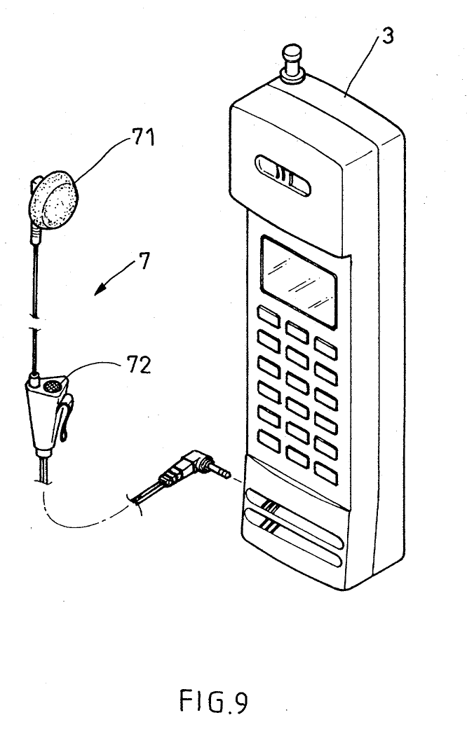

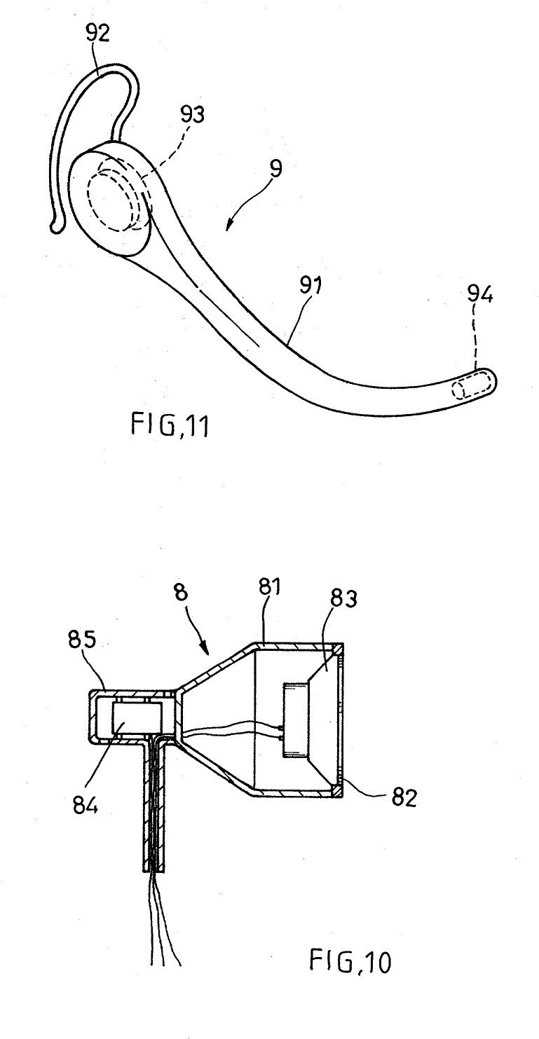

FIG. 8 shows an earphone type transmitter receiver apparatus 6 according to a fourth embodiment of the present invention. According to this embodiment, the earphone type transmitter receiver apparatus 6 comprises a housing 61 defining an upper chamber 61 and a lower chamber 62, a hook 63 protruded from the housing 61 and adapted for hanging the earphone type transmitter receiver apparatus 6 on the user's ear, an insertion tip 64 protruded from one side of the housing 61 and adapted for inserting into the user's ear, the insertion tip 64 defining an upper sound wave passage 641 in communication with the upper chamber 61 and a lower sound wave passage 642 in communication with the lower chamber 62, a speaker 611 mounted in the upper chamber 61, and a microphone 14 mounted in the lower chamber 62.

A prototype of earphone type transmitter receiver apparatus has been constructed with the features of FIGS. 1˜8. The earphone type transmitter receiver apparatus functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An earphone type transmitter receiver apparatus comprising:
a housing adapted for inserting into the user's ear, said housing having a front opening covered with a grille and an earphone cushion on said grille,
a speaker mounted in said housing for output of sound from an external sound source; and
a microphone mounted in said housing for picking up the user's sound waves from the ear of the user in which said housing is inserted.

2. The earphone type transmitter receiver apparatus as claimed in claim 1, wherein said grille has a forwardly extended center barrel; said microphone is mounted in the center barrel of said grille; said speaker is fastened to an inside wall of said grille inside said housing.

3. The earphone type transmitter receiver apparatus as claimed in claim 2 further comprising a wireless transmitting receiving circuit assembly mounted inside said housing and electrically connected to said microphone and said speaker for communication with an external mobile telephone by radio.

4. The earphone type transmitter receiver apparatus as claimed in claim 1, wherein said microphone is fixedly mounted in an inside wall of said grille inside said housing, and said speaker is fixedly mounted inside said housing remove from said grille.

5. The earphone type transmitter receiver apparatus as claimed in claim 1, wherein said speaker is fixedly mounted in an inside wall of said grille, and said microphone is fixedly mounted in an inside wall of said housing remote from said grille.

6. The earphone type transmitter receiver apparatus as claimed 1, wherein said housing comprises an upper chamber, which holds said speaker on the inside, a lower chamber, which holds said microphone on the inside, an insertion tip protruded from one side thereof and adapted for inserting into the user's ear, a first sound wave passage extended through said insertion tip in communication with said upper chamber, and a second sound wave passage extended through said insertion tip in communication with said lower chamber.

7. The earphone type transmitter receiver apparatus as claimed 6, wherein said housing comprises a hook adapted for hanging the earphone type transmitter receiver apparatus on the user's ear.
